(19) United States
(12) Patent Application Publication
(10) Pub. No.: US 2010/0262651 A1
(43) Pub. Date: Oct. 14, 2010

(54) METHOD TO PREVENT SERVER OVERLOAD FOR BROADCAST PROTOCOLS BY ADAPTIVELY APPLYING PRESCRIBED RESPONSE BEHAVIOR PROFILES

(75) Inventors: Nhut Nguyen, Richardson, TX (US); Kong Posh Bhat, Plano, TX (US); Mark Trayer, Plano, TX (US)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/728,849

(22) Filed: Mar. 22, 2010

Related U.S. Application Data
(60) Provisional application No. 61/212,310, filed on Apr. 9, 2009.

(51) Int. Cl. G06F 15/16

(52) U.S. Cl. 709/203

(57) ABSTRACT

In a communication system, a server is operable to control responses from a number of client devices to prevent overload conditions of the server resulting from the responses. The server includes a controller configured to select a desired response profile for a plurality of broadcast client devices from a plurality of response profiles based upon current resource conditions and to include a prescribed response behavior for the client in the broadcast message. The broadcast message includes a response control field providing information regarding the desired response profile. The client devices include a receiver configured to receive the broadcast message. The client devices also include a controller configured to decode the control field in the broadcast message to determine the response behavior and respond to the broadcast message as prescribed by the server.

### CROSS-REFERENCE TO RELATED APPLICATION(S) AND CLAIM OF PRIORITY

The present application is related to U.S. Provisional Patent No. 61/212,310, filed Apr. 9, 2009, entitled “FLEXIBLE SERVER OVERLOAD PROTECTION MECHANISM FOR BROADCAST PROTOCOLS”. Provisional Patent No. 61/212,310 is assigned to the assignee of the present application and is hereby incorporated by reference into the present application as if fully set forth herein. The present application hereby claims priority under 35 U.S.C. §119(e) to U.S. Provisional Patent No. 61/212,310.

### TECHNICAL FIELD OF THE INVENTION

The present application relates generally to communications systems and, more specifically, to a system and method for server overload control by applying behavior profiles in broadcast protocols.

### BACKGROUND OF THE INVENTION

In a telecommunications network it is often necessary for a server to broadcast a message to a large number of clients. The message may be used to provide information to the clients, or to instruct the clients to perform some actions. An example of such situation is in the Open Mobile Aliance Device Management (OMA-DM) protocol when a Device Management (DM) server needs to instruct thousands of DM clients to apply a critical patch. These clients responding to the broadcast message may send back thousands response messages to the server which may overload and eventually crash the server. Accordingly, there is a need for a proactive overload control method as existing methods are mostly reactive.

### SUMMARY OF THE INVENTION

A server is provided. The server includes a controller configured to select a desired response profile for a plurality of broadcast client devices from a plurality of response profiles based at least partly upon one or more current resource conditions. The broadcast server uses a broadcast server which includes a transmitter configured to transmit a broadcast message. The broadcast message includes a response control field providing information regarding the desired response profile.

A method for operating a server is provided. The method includes selecting a desired response profile for a plurality of broadcast client devices from a plurality of response profiles based at least partly upon one or more current resource conditions. The method also includes encoding the desired response profile into a control field of a broadcast message.

A client device is provided. The client device includes a receiver configured to receive a broadcast message. The client device also includes a controller configured to decode a control field in the broadcast message to determine a response behavior.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the use of a broadcast protocol in a communication network;

FIG. 2 illustrates a broadcast server according to embodiments of the present disclosure;

FIG. 3 illustrates an exemplary wireless client according to embodiments of the present disclosure;

FIG. 4 illustrates a communication system with a network configuration using a broadcast protocol according to embodiments of the present disclosure;

FIG. 5 illustrates OMA-DM protocol phases according to embodiments of the present disclosure;

FIG. 6 illustrates the OMA-DM notification message according to embodiments of the present disclosure;

FIG. 7 illustrates the trigger header according to embodiments of the present disclosure;

FIG. 8 illustrates a server overload control process according to embodiments of the present disclosure; and

FIG. 9 illustrates a client response process according to embodiments of the present disclosure

### DETAILED DESCRIPTION OF THE INVENTION

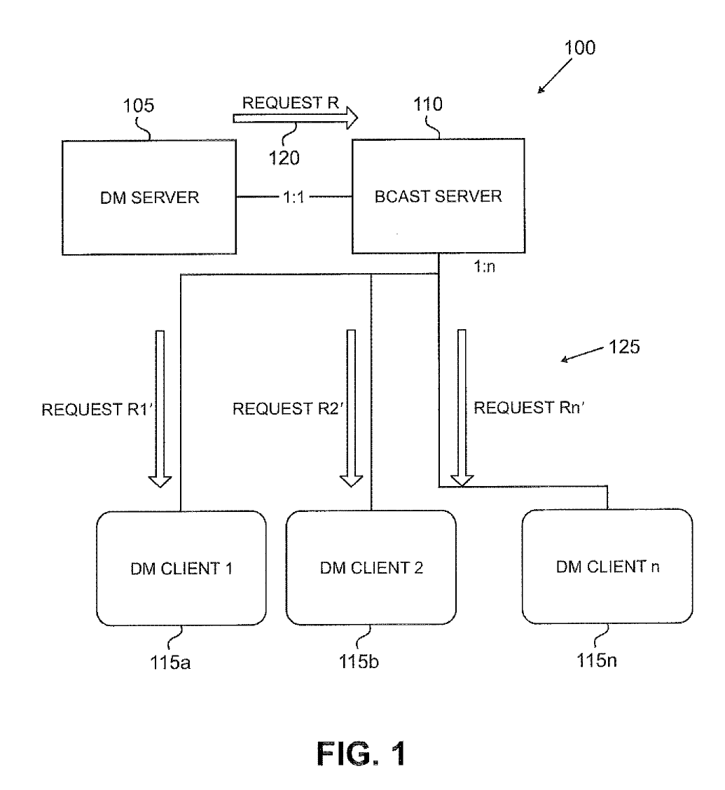

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network.

FIG. 1 illustrates the use of a broadcast protocol in a communication network. More particularly, FIG. 1 shows the interaction between the server and clients during a broadcast of OMA-DM protocol messages. It will be understood that OMA-DM protocols are illustrated throughout this disclosure for example and ease of illustration. However, other broadcast protocols could be used without departing from the scope of this disclosure.

The communication network 100 includes a DM server 105, a broadcast server 110 and a plurality of DM clients 115a-n. The number of targeted clients 115a-n can be tens or even hundreds of thousands.

The DM server 105 sends a DM request (R) 120 destined for each of the clients 115a-n. In order to efficiently deliver the request 120 to the clients 115a-n, the DM server 105 sends the request 120 to the broadcast server 110. The broadcast server 110 is operable to transmit a broadcast message 125 to be received by each of the clients 115a-n. The broadcast message 125 includes the request 120 request destined for each client 115a-n. As such, the single request 120 from the DM server 105 results in multiple requests (R1′, R2′, . . . , Rn′) to be sent to the targeted clients 115a-n.

Upon receiving a request, each DM client 115a-n sends back a response to the DM server 105. As a result of the request 120, the DM server 105 will receive tens of thousands response messages from targeted clients.

As illustrated by way of example above with broadcast protocols, when the number of DM clients 115a-n is on the order of tens or hundreds of thousands, the DM server 105 may be overwhelmed with the number of responses coming back from the clients 115a-n. When this occurs, depending upon its resource conditions, the DM server 105 may become overloaded and even crash.

Many techniques exist to protect a server from overload condition. However most of these techniques are designed to reactively protect the DM server 105. With these techniques, the DM server 105 is often required to discard responses that already have arrived at the server and/or to send a throtling message to one or more of the clients 115a-n. A throtling message can be a message indicating that the server 105 is busy and not ready to receive broadcast messages. If responses are discarded, the clients 115a-n may have to resend the response, which requires a complicated protocol design. The resent responses together with throtling messages can increase network traffic significantly.

Embodiments of the present disclosure provide a system and method that adapts to DM server's 105 current resource conditions, to proactively prevent server overload conditions. By prescribing response behavior profiles and adaptively selecting a desired profile for the moment, the DM server 105 is able to manage the flow of response messages from clients 115a-n in a predictive and effective manner. As such, the DM server 105 can avoid being flooded with response messages from clients 115a-n.

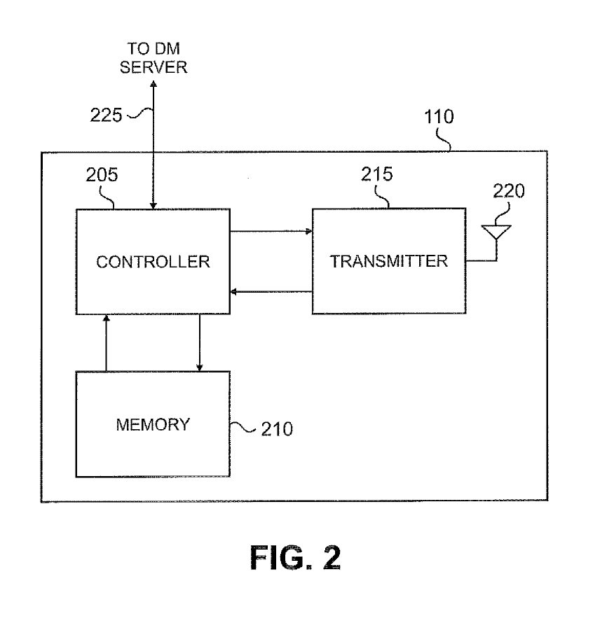

FIG. 2 illustrates a broadcast server according to embodiments of the present disclosure. The embodiment of broadcast server 110 illustrated in FIG. 2 is for illustration only. Other embodiments of the broadcast server 110 could be used without departing from the scope of this disclosure. The server 105 uses the broadcast server in FIG. 2 to broadcast a message to plurality of broadcast client devices.

broadcast server 110 includes a controller 205, a memory 210 and a transmitter 215. The transmitter 215 can be coupled to an antenna 220. A controller 205 is a device that manages communications resources, including the transmitter 215. The transmitter 215 can be a transceiver that includes one or more receivers and one or more transmitters. The transmitter 215 is configured transmit a broadcast message comprising a response control field providing information regarding a desired response profile.

The controller 205 includes processing circuitry capable of executing an operating program that communicates with DM server 105 and controls the overall operation of broadcast server 110. According to some embodiments of the present disclosure, the controller 205 is operable to execute programs, such as an operating system (OS) and processes for applying behavior profiles, stored in a memory 210. Memory 210 can be any computer readable medium, for example, the memory 210 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. Memory 210 comprises a random access memory (RAM) and another part of memory 210 comprises a Flash memory, which acts as a read-only memory (ROM).

The controller 205 is operable to control the broadcasting of messages to the DM clients 115a-n. The controller 205 can communicates to DM server 105 via the connection 225.

In some embodiments, the broadcast server 110 is included in a wireless network base station (not specifically illustrated). In some embodiments, the broadcast server 110 can communicate via one or more wireless protocols, such as, Bluetooth®, IEEE 802.11 (Wireless Fidelity (WiFi), Wireless Max (WiMAX)) or any other wireless protocol. In other embodiments, the broadcast server 110 may communicate with the clients using wire-line media and associated protocols.

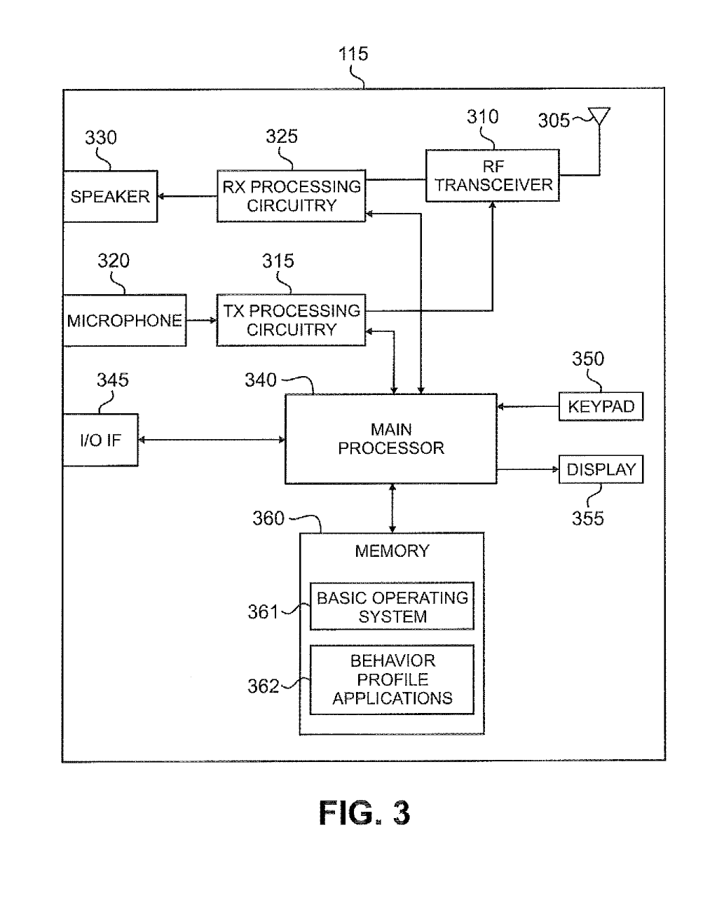

FIG. 3 illustrates an exemplary wireless client according to embodiments of the present disclosure. The embodiment of wireless client 115 illustrated in FIG. 3 is for illustration only. Other embodiments of the wireless client 115 could be used without departing from the scope of this disclosure.

Wireless client 115 includes antenna 305, radio frequency (RF) transceiver 310, transmit (TX) processing circuitry 315, microphone 320, receive (RX) processing circuitry 325, main processor 340, and memory 360. Client 115 also can include speaker 330, input/output (I/O) interface (IF) 345, keypad 350, and display 355. Memory 360 further comprises basic operating system (OS) program 361 and applications for behavior profiles and broadcast message response 362.

Radio frequency (RF) transceiver 310 receives from antenna 305 an incoming RF signal transmitted by the broadcast server 110 through a base station of wireless network 100. Radio frequency (RF) transceiver 310 down-converts the incoming RF signal to produce an intermediate frequency (IF) or a baseband signal. The IF or baseband signal is sent to receiver (Rx) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of the present disclosure, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. In some embodiments, the main processor 340 is configured execute programs, such as OS 361 and applications for behavior profile determination and responding to broadcast messages 362. The main processor 340 can execute the behavior profile applications 362 based on OS program 361 or in response to a signal received from broadcast server 110. For example, main processor 340 is operable to decode a control field in a received broadcast message to determine a response behavior.

Main processor 340 also can be coupled to I/O interface 345. I/O interface 345 provides client 115 with the ability to connect to other devices such as laptop computers and handheld computers. I/O interface 345 is the communication path between these accessories and main controller 340.

Main processor 340 can be also coupled to keypad 350 and display unit 355. The operator of client 115 can use keypad 350 to enter data into client 115. Display 355 may be a liquid crystal display capable of rendering text and/or at least limited graphics from web sites. Alternate embodiments may use other types of displays.

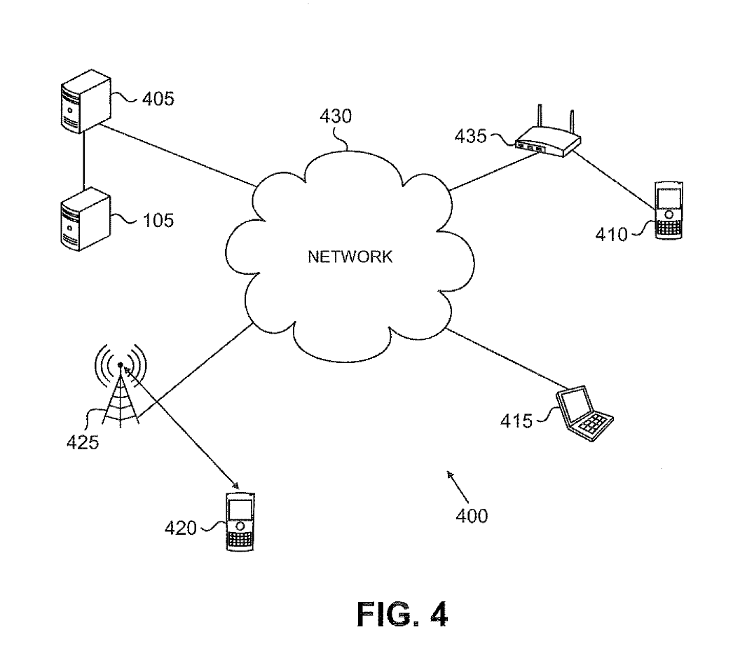

FIG. 4 illustrates a communication system with a network configuration using a broadcast protocol according to embodiments of the present disclosure. The embodiment of the communication system 400 shown in FIG. 4 is for illustration only. Other embodiments could be used without departing from the scope of this disclosure.

The communication system 400 includes the server 105 coupled to a broadcast server 405. For simplicity only one broadcast server 405 is shown in FIG. 4; however the system 400 may include more than one broadcast server 405. The broadcast server 405 can include the same structure and functionality as the broadcast server 110. Clients 410, 415, and 420 can communicate through the network 430 with the broadcast server 405 using various physical medium, such as wired and wireless communication mediums. Clients 410, 415, and 420 can include the same structure and or functionality as client 115. Clients 410 and 420 reside on mobile terminals while client 415 resides on a fixed terminal, such as a home gateway. Client 410 may connect to the network through a wireless access point 435. In addition, Client 420 may connect to the network 430 through a base station 425. In the communication system 400, the number of clients (such as clients 410-420) that broadcast server 405 communicates with can be as large as several tens or even hundreds of thousands.

In the broacast protocol, the broadcast server 405 broacasts a message to a set of clients that are listening to a broadcast channel. The broadcast message includes information that the broadcast server 405 (or the DM server communicating through the broadcast server 405) wants to convey to the clients 410-420 and/or commands that one or more of the clients 410-420 may have to perform.

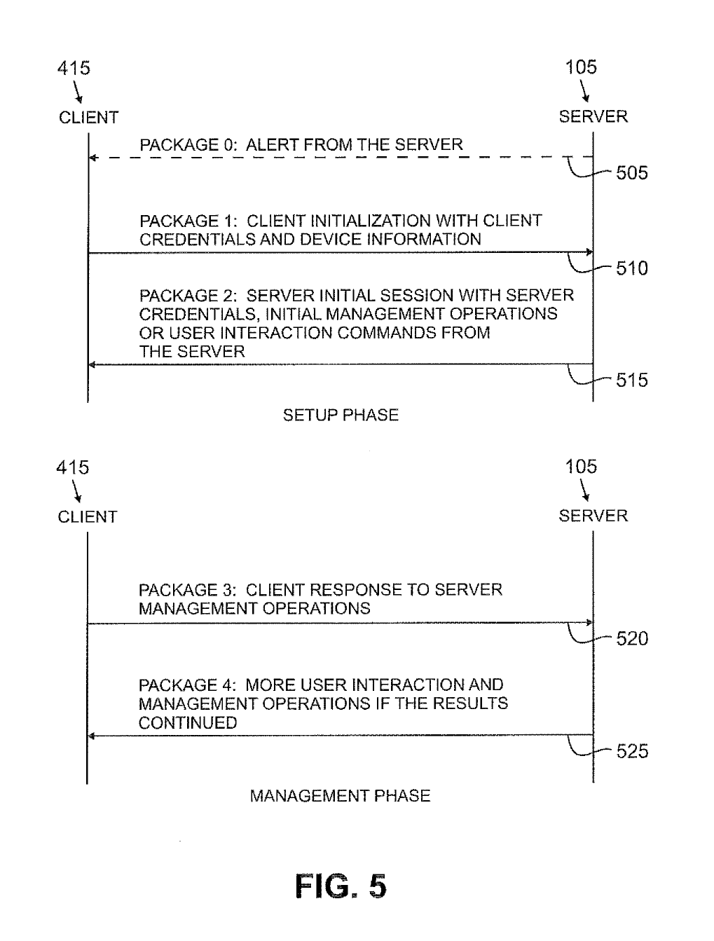

FIG. 5 illustrates OMA-DM protocol phases according to embodiments of the present disclosure. The embodiment of the OMA-DM protocols shown in FIG. 5 is for illustration only. Other embodiments could be used without departing from the scope of this disclosure.

As an example, a firmware/software upgrade feature of OMA-DM may utilize a broadcast protocol whereby two messages are broadcasted to multiple mobile terminals that need to be updated. The first message is a DM notification message as disclosed in OMA Device Management Notification Initiated Session, Version 1.2, Feb. 9, 2007, Open Mobile Alliance, OMA-TS-DM_Notification-V1_{—}2-20070209-A, the contents of which hereby are incorprated by reference. The purpose of this message is to inform the device of an impending software update, so that the device can prepare itself for for receiving the new package (containing new software/firmware). The second message contains the new package itself.

The server 105 sends DM notification message (Package 0) 505 to the client, such as client 415. The server 105 can send DM notification message 505 directly or through a broadcast server, such as broadcast server 405. DM notification message 505 is an alert message that can be configured to inform the clients, such as client 415, of an impending software update, so that the client 415 can prepare itself for for receiving the new package (containing new software/firmware).

In the OMA-DM protocol described in OMA Device Management standards, upon receiving the DM notification message 505, the DM client 415 checks the identifier of the requesting server 105. If the server 105 has been previously bootstrapped, the DM client 415 initiates a management session with the DM server 105 by sending a client initialization message (Package 1) 510 to the DM server 105. The client initialization message 510 includes the client credentials and device information. Thereafter, the DM server 105 transmits the server initialization message (Package 2) 515. The server initialization message 515 includes the server credentials, initial management operations or user interaction commands from the server 105. The messages, 505, 510 and 515 comprise the setup phase messages. Thereafter, the client 415 transmits a client response message (Package 3) 520 to the server 105 and the server 105 transits more user interaction messages (Package 4) 525 if the session is continued.

While this approach works well with point-to-point communication between the DM server 105 and the DM client 415, it does not scale in a broadcast protocol very well. For example, when the number of targeted mobile terminals is on the order of tens of thousands the DM server 105 may become overwhelmed with response messages 510 and 520.

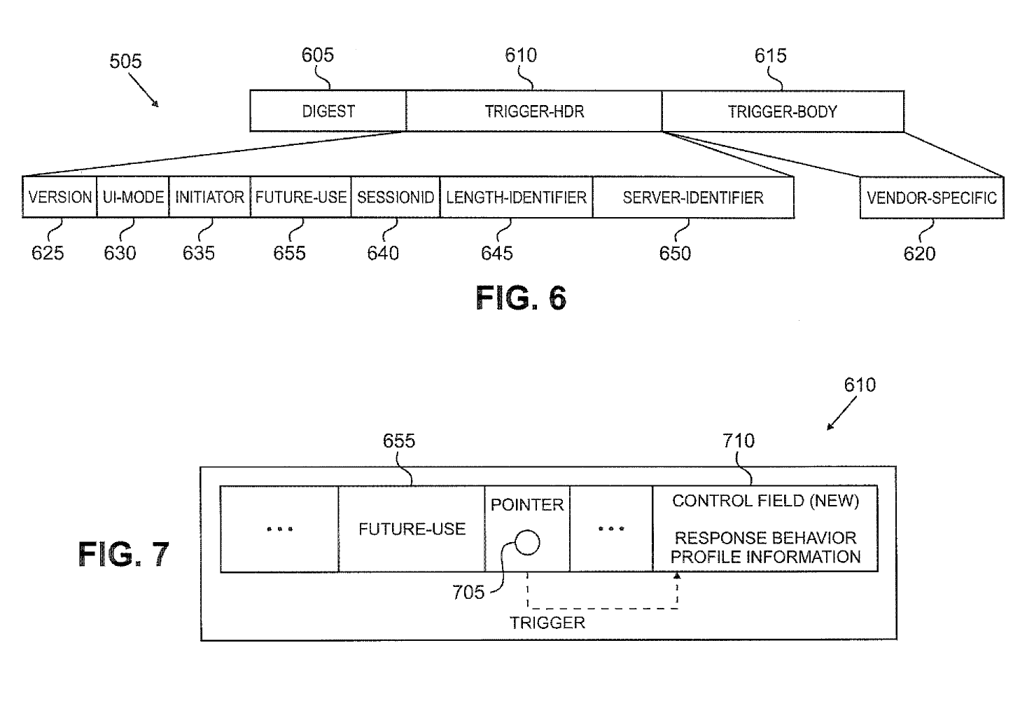

FIG. 6 illustrates a notification message according to embodiments of the present disclosure. The embodiment of the notification message 505 shown in FIG. 6 is for illustration only. Other embodiments could be used without departing from the scope of this disclosure.

The notification message 505 includes a digest 605 a trigger header 610 and a trigger body 615. The digest 605 can be used for integrity checking. The trigger body 615 can include a vendor specific field 620.

The trigger header 610 can include a version 625, a ui mode 630, an initiator 635, a session identifier 640, a length identifier 645 and a server identifier 650. The trigger header also includes a reserved (that is, future use) field 655.

FIG. 7 illustrates the trigger header 610 according to embodiments of the present disclosure. The embodiment of the trigger header 610 shown in FIG. 7 is for illustration only. Other embodiments of the trigger header 610 could be used without departing from the scope of this disclosure.

In some embodiments, the server 105 uses a portion of the reserved field 655 as a pointer 705 that points to a response control field 710 in the notification message 505 to prescribe how the clients 410-420 should handle the response. The pointer 705 can be an offset that directs the client 415 to the control field 710. The response control field 710 may include, for example, necessary information to control how the client 415 should respond to the broadcast message.

The server 105 can use the response control field 710 to prescribe a profile that the server 105 desires for responses from the clients 410-420. In the broadcast environment, the same request is sent to all clients 410-420; however, by using the response control field 710, the server 105 can specify different desired response behaviors for different sets of clients 410-420. As such, the server 105 can proactively and individually manage the response messages to be sent back from each of the clients 410-420.

The control field 710 can contains information related to the prescribed response behavior profile. Including the control field 710 with the desired response behaviour profiles enables flexible and effective overload control for server 105. A response behavior profile is a collection of response behaviors of all clients 410-420 that receive the broadcast message. The response control field 710 contains necessary information related to the desired response behavior profile for a particular broadcast message that the server 105 wants to communicate to all clients. The desired response behaviour profile is operable to control the flow response messages from the clients 410-420 and, thus, proactively avoid server overload conditions

Upon receiving a broadcast message, the client 415 uses a response behavior as prescribed by the server 105 in the control field 710 to respond to the broadcast message. For example, the response behaviors of the client 415 can include:

1. Responding immediately;

2. Waiting for a specified period of time before responding;

3. Waiting for a random period of time before responding;

4. Responding only if certain conditions are met, such as when the identification number of the client is an even number; and

5. Not responding and, instead, storing the response in the memory 360.

The response behaviors shown here are for example, and many other response behaviors could be used without departing from the scope of this disclosure. Further, each client device 410-420 is configured to determine its own response behavior based on the response profile determined in the response control field 710. In addition, each client device 410-420 can determine a different response behavior from the same behavior profile. For example, when the server sends out a prescribed response profile that is included in the response control field 710, the client 415 can respond with a first behavior, such as by not responding and storing the response in memory, while the client 410 responds using a second behavior, such as waiting for a random period of time before responding. In addition, one or more groups may respond using the same response behavior

A response behavior profile can contain the response behavior for all clients 410-420 upon receiving a broadcast message from the broadcast server 405. For example, the desired response profile can be a staging response profile whereby the clients 410-425 are grouped into n groups and each group responds to the broadcast message in different time periods (that is, at different times). In some embodiments, the server 105 can regroup the clients 410-420 such that client 415 may be in a first group during one broadcast message cycle and in another group during a subsequent message cycle. The number of group n, the amount of time T allocated to each group, as well as when a group can start responding can be modified and specified by the server 105.

In some embodiments, each of the groups n can apply a different response behavior to the response profile. For example, the client 415 can be a member of a first group and client 410 can be a member of a second group. When the server sends out a prescribed response profile that is included in the response control field 710, the client 415 can respond with a first behavior, such as by responding if certain conditions are met, while the client 410 responds using a second behavior, such as responding immediately. In addition, one or more groups may respond using the same response behavior.

By prescribing the desired response behavior profile, the server 105 can manage the reception of the response messages from one or more clients 410-420 in a controlled and predictive manner, thus avoiding overload conditions. Furthemore the server 105 can fine tune the overload control mechanism by including parameters associated with the response behavior profile (such as the parameters n and T illustrated above) in the control field 710 of the broadcast message. As such, the server 105 can use the control field 710 to fine tune overload control operations.

With this mechanism, the server 105 can have a great degree of control over the granularity of overload control for the system and, thus, more effective overload control operations can be achieved.

For example, following response behavior profiles can be envisioned to control the responses from the clients 410-420.

Distributed behaviors profile: A set of k response behaviors are evenly distributed among the clients 410-420 to spread out the response messages from the clients 410-420.

Staging response profile: the clients 410-420 are grouped to n groups and each group will respond in a staged manner, that is, each group will respond sequentially in turn, for a period of time T seconds. By staging the response messages over n periods of time, the server 105 can proactively manage overload conditions.

Random wait profile: the clients 410-420 will wait a random time (maximum Tw seconds) before responding. Similar to the staging response profile, the response messages from the clients 410-420 will arrive to the server over a period of time, and as such can help avoid overloading the server.

Polling profile: the clients 410-420 store the response message in their memory 360 and the server 105 polls and collects response messages at a later time.

The response behavior profiles described are only examples and the list is not an exhaustive list of response behavior profiles. Many other response behaviors, such as yet-to-be-invented profiles, could be used without departing from the scope of this disclosure.

In some embodiments, the required information associated with each profile (such as parameters k, n, T, Tw) can be encoded and included in the control field 710. Encoding and including the required information associated with each provide can provide the server 105 with greater control over the overload control mechanisms to be applied for each broadcast message.

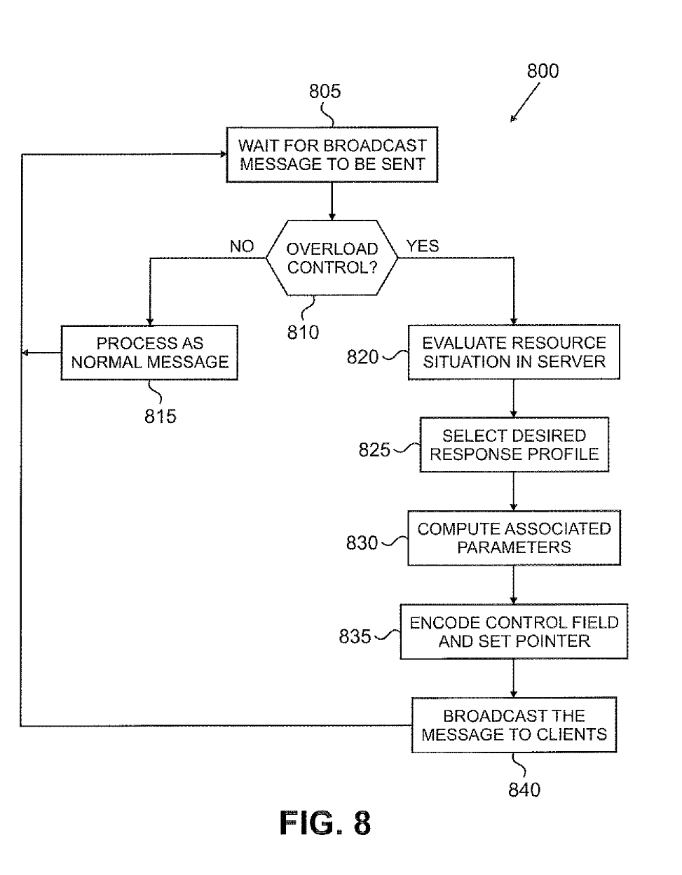

FIG. 8 illustrates a server overload control process according to embodiments of the present disclosure. The embodiment of the server overload control process 800 shown in FIG. 8 is for illustration only. Other embodiments could be used without departing from the scope of this disclosure.

The server 105 can define a list of response behaviors that it expects from the clients 410-420. The broadcast server 405 sends the list to the clients 410-420 to be store in a client's memory. The server 105 also can generate a set of response behavior profiles according to its resource conditions beforehand. The server 105 can store the set of response behaviour profiles in a database included in memory 210. For example, one entry of the database may contain a simple rule stating ‘if the processor occupancy is 60% then use the staging response profile’. In addition, the server 105 can utilize sophisticated processes, such as taking into account the number as well as characteristics of each client 410-420, to generate a set of adaptive response behavior profiles to further enhance the efficiency of the overload control process.

In block 805, the server 105 waits for a broadcast message to be sent. When a broadcast message needs to be sent to the client 415, the server 105 determines if overload control is needed in block 810.

If overload control is not need, the server 105 processes the broadcast message as a normal broadcast message in block 815. For example, the broadcast message is sent as a normal OMA-DM message. Thereafter, the server 105 returns to block 805 to wait for another broadcast message to be sent.

If overload control is needed, the server 105 evaluates the resource situation in block 820. The server 105 examines the current resource situation, such as processor load, available memory, and so forth. In block 825, the server 105 uses the current resource situation data found in block 820 to select a response profile to be prescribed to the clients. For example, the server 105 can used the current resource situation data to select a staging profile as an desired (optimal or best) response profile. In block 830, the server 105 computes the associated data, such as fine tuning information for the profile. In block 835, the server 105 encodes the selected respond behavior profile and the associated data and places them into the control field 710 of the notification message 505. The server 105 also sets the pointer 705 in the notification message 505. Then, the server 105, via the broadcast server 405, transmits the message to the clients 410-420 in block 840. Thereafter, the server 105 returns to block 805 to wait for another broadcast message to be sent.

By evaluating the resource condition in block 820 and selecting a desired response profile according to the current resource situation in block 825, the server 105 can prescribe a very effective overload control profile by proactively adapting to the current resource situation. That is, the server 105 can execute the overload control mechanism to dynamically adapt to the current resource situation of the server 105.

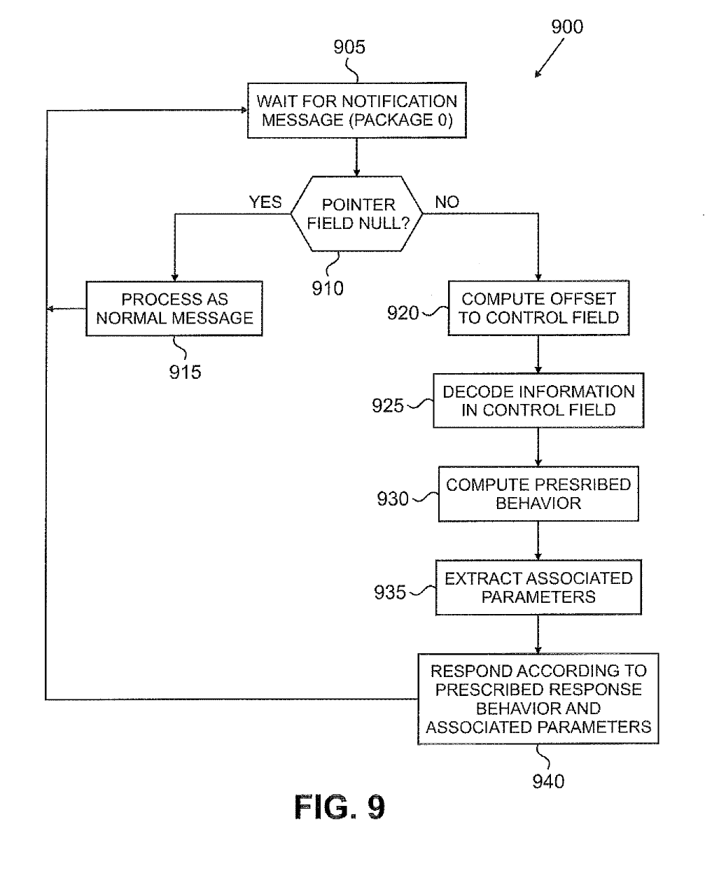

FIG. 9 illustrates a client response process according to embodiments of the present disclosure. The embodiment of the client response process 900 shown in FIG. 9 is for illustration only. Other embodiments could be used without departing from the scope of this disclosure.

In block 905, the client 415 waits for the notification message 505 to be received. When the notification message 505 is received, the client 415 checks the pointer field 705 of the the notification message 505 to determines, in block 910, if a desired behaviour is requested by the server.

If the pointer 705 is NULL, the client 415 processes the broadcast message as a normal broadcast message in block 915. For example, the client 415 transmits a response as a normal OMA-DM response. Thereafter, the client 415 returns to block 905 to wait for another notification message 505 to be received.

If the pointer 705 is not NULL, the client 415 determines that the server 105 has prescribed a response behavior for the client in the control field. In block 920, the client 415 computes an offset to the control field 710. In block 925 the client 415 decodes the control field 710 to extract the prescribed response behavior profile. From the response behavior profile, the client 415 computes the response behavior in block 930. In some embodiments, the client 415 can compute the response behavior by referring to a table look up stored in memory 360. In some embodiments, the client 415 can execute a series of instructions stored in memory 360 to determine the response behavior. For example, if the response behavior profile is to evenly distribute k response behaviors across the clients 410-420, the client 415 can apply a modulos(k) function might to a random number, such as the time of the message arrival, in order to compute the response behavior to be used by the client 415.

In block 935, the client 415 extracts the overload control parameters associated with the prescribed response behavior. Then, in block 940, the client 415 uses the prescribed response behavior and associated parameter to handle response processing of the notification message 505.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A server comprising:
a controller configured to select a desired response profile for a plurality of broadcast client devices from a plurality of response profiles based upon current resource conditions, and configured to prepare a broadcast message comprising a response control field providing information regarding the desired response profile.

2. A server in accordance with claim 1 wherein the current resource conditions include at least one of available processor cycles and available memory.

3. A server in accordance with claim 1 wherein the plurality of response profiles includes a distributed behaviors profile in which a set of two or more response behaviors are distributed among the plurality of broadcast client devices.

4. A server in accordance with claim 1 wherein the plurality of response profiles includes a staging response profile in which the plurality of broadcast client devices are grouped into two or more sets of broadcast client devices and the sets of broadcast client devices send a response message to the broadcast message sequentially in turn over a period of time in a staged manner.

5. A server in accordance with claim 1 wherein the plurality of response profiles includes a random wait profile in which the plurality of broadcast client devices wait a random time before sending a response message to the broadcast message.

6. A server in accordance with claim 1 wherein the plurality of response profiles includes a polling profile in which a broadcast client device stores a response message to the broadcast message in a memory of the broadcast client device and the server collects the response message at a later time.

7. A server in accordance with claim 1 wherein the desired response profile includes at least one of the following response behaviors:
responding immediately,
waiting for a pre-determined period of time before responding,
waiting for a random period of time before responding,
responding only if a particular condition is met, and
storing response in a memory of a broadcast client device.

8. A server in accordance with claim 1 wherein the transmitter is further configured to transmit response behaviors associated with the desired response profile to the plurality of broadcast client devices.

9. A method of operating a server, the method comprising:
selecting a desired response profile for a plurality of broadcast client devices from a plurality of response profiles based upon current resource conditions; and
encoding the desired response profile into a control field of a broadcast message.

10. A method in accordance with claim 9 wherein the current resource conditions include at least one of available processor cycles and available memory.

11. A method in accordance with claim 9 wherein the plurality of response profiles includes a distributed behaviors profile in which a set of two or more response behaviors are distributed among the plurality of broadcast client devices.

12. A method in accordance with claim 9 wherein the plurality of response profiles includes a staging response profile in which the plurality of broadcast client devices are grouped into two or more sets of broadcast client devices and the sets of broadcast client devices send a response message to the broadcast message sequentially in turn over a period of time.

13. A method in accordance with claim 9 wherein the plurality of response profiles includes a random wait profile in which the plurality of broadcast client devices wait a random time before sending a response message to the broadcast message.

14. A method in accordance with claim 9 wherein the plurality of response profiles includes a polling profile in which a broadcast client device stores a response message to the broadcast message in a memory of the broadcast client device and the server collects the response message at a later time.

15. A method in accordance with claim 9 wherein the desired response profile includes at least one of the following response behaviors:
responding immediately,
waiting for a pre-determined period of time before responding,
waiting for a random period of time before responding,
responding only if a particular condition is met, and
storing response in a memory of a broadcast client device.

16. A method in accordance with claim 9 further comprising transmitting response behaviors associated with the desired response profile to the plurality of broadcast client devices.

17. A client device comprising:
a receiver configured to receive a broadcast message; and
a controller configured to decode a control field in the broadcast message to determine a response behavior prescribed by the server.

18. A client device in accordance with claim 17 wherein the determined response behavior includes at least one of the following response behaviors:
responding immediately,
waiting for a pre-determined period of time before responding,
waiting for a random period of time before responding,
responding only if a particular condition is met, and
storing response in a memory of the broadcast client device.

19. A client device in accordance with claim 17 wherein the controller is configured to decode the control field in the broadcast message to determine the response behavior as prescribed by the server.

20. A client device in accordance with claim 17 wherein the controller is configured to decode the control field in the broadcast message to determine the response behavior as prescribed by the server, and then respond to the broadcast message accordingly to the determined response behavior.
